(19) United States
(12) Patent Application Publication
(10) Pub. No.: US 2006/0095675 A1
(43) Pub. Date: May 4, 2006

(54) Three stage hybrid stack model

(76) Inventors: Rongzhen Yang, Shanghai (CN); Feng Chen, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/925,188

(22) Filed: Aug. 23, 2004

(51) Int. Cl. G06F 12/00

(52) U.S. Cl. 711/132; 712/202

(57) ABSTRACT

A three-stage hybrid stack model includes two separate stages of registers, or in other words, two register stacks. Below the two register stages is a memory stage, or memory stack. As operands are pushed onto the top register stack, operands residing in registers are moved down to accommodate the new operands. A second register stack, or transfer register stack receives overflow from the top register stack and supplies operands to the top register stack when the top register stack is underflowed. A third stage made up of memory locations is used to store overflow from the transfer register stack. The memory stack also supplies operands to the transfer register stack as needed.

### TECHNICAL FIELD

The invention relates to stack models. More particularly, the invention relates to a hybrid memory/register stack model applicable to stack caching.

### BACKGROUND

There are two common ways to run programs written in a high-level language. One method is to compile the source code to create executable machine code, and then execute the machine code. Another method is to pass the source code through an interpreter. An interpreter translates the high-level instructions in the source code into an intermediate form, which it then executes. Interpreters are valuable in building a virtual machine using a stack-based language despite the fact that compiled programs typically run faster than interpreted programs. The advantage of an interpreter, however, is that it does not need to go through the compilation stage during which machine instructions are generated.

The compiler used in a virtual machine (e.g. Java Virtual Machine) environment, also known as a Just-In-Time compiler, is used to compile bytecode into machine instructions. Similarly, the interpreter used in a virtual machine is a bytecode interpreter. It is used to interpret bytecode into machine instructions. Compared to the Just-In-Time compiler, the bytecode interpreter has a smaller footprint, along with the additional benefits of simplicity and portability.

On a register-based computer architecture, the classic approach to implementing an interpreter using a stack-based language is to use a memory data structure to imitate a stack. When virtual machine instructions use operands, those operands are retrieved from memory. Accessing memory is substantially more time consuming than accessing registers. Thus, the cost of accessing memory for each operand can be significant and may create a performance bottleneck in the system.

One solution to the performance bottleneck is stack caching. Stack caching involves keeping source and destination operands of instructions in registers so as to reduce memory accesses during program interpretation. Stacks exhibit a last-in-first-out (LIFO) behavior when pushing and popping operands to and from the stack. Thus, in a stack-programming model, the top part of an operand stack contains the most recently used operands.

In stack caching, the operand stack spans a set of registers and memory locations, and is, therefore, often referred to as a hybrid stack. Given that the top of the operand stack contains the most recently used operands, the top part of the operand stack is comprised of registers. The lower part of the operand stack is made up of memory locations. The upper portion of the hybrid stack containing registers is referred to as the register stack while the lower portion of the hybrid stack containing the memory locations is called the memory stack. When combined, the register stack and the memory stack form the overall hybrid stack model.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of a three-stage hybrid stack.

FIG. 2a illustrates the moving of operands in a hybrid stack model.

FIG. 2b illustrates the moving of operands in a hybrid stack model.

FIG. 3a is a block flow diagram of one embodiment of the invention.

FIG. 3b is block flow diagram of one embodiment of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

The three-stage hybrid stack model described herein can be used in an implementation of a virtual machine. One example is Intel Corporation's Java virtual machine, Xorp, for its Xscale® microarchitecture. In another embodiment, the three-stage hybrid stack model could be used in a stack model CPU, or stack machine, to implement a stack architecture more efficiently.

In a one embodiment, the three-stage hybrid stack model is used in an implementation of an interpreter in a virtual machine. The invention improves the efficiency of stack caching by introducing a transfer register stack, which reduces memory accesses during interpretations. In another embodiment, the three-stage hybrid stack model is used in a compiler.

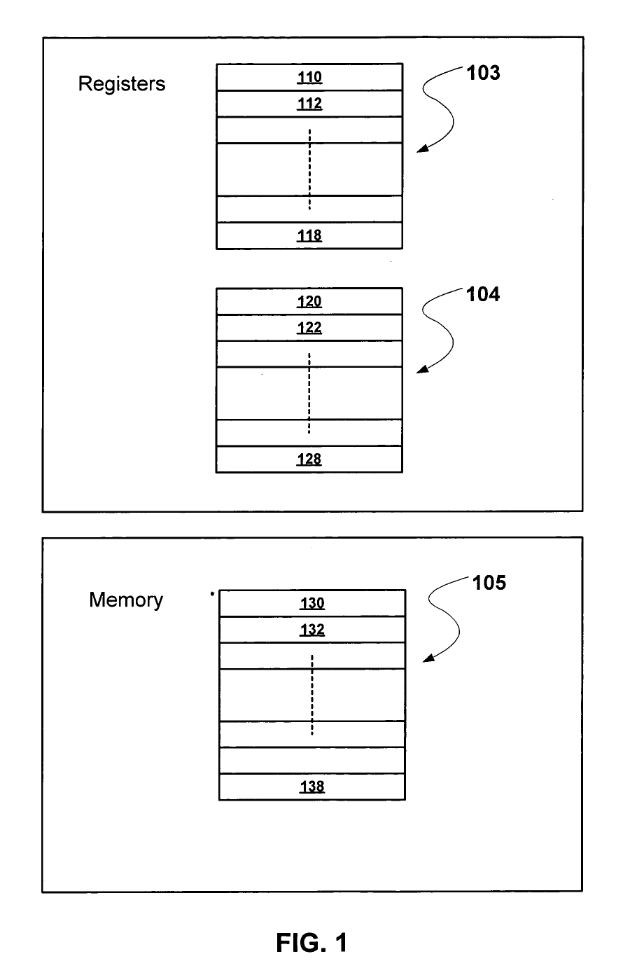

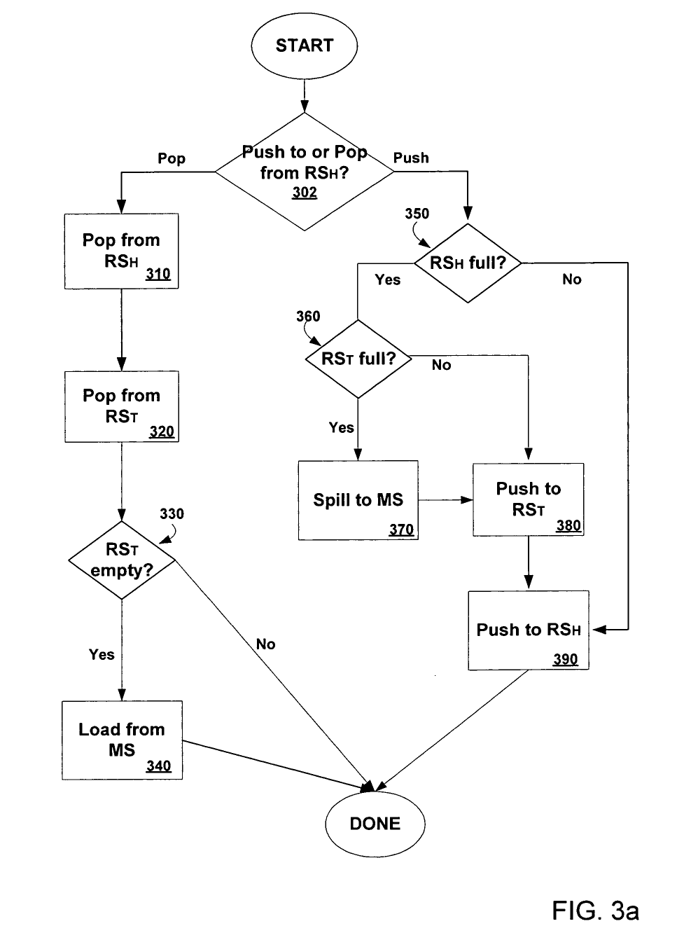

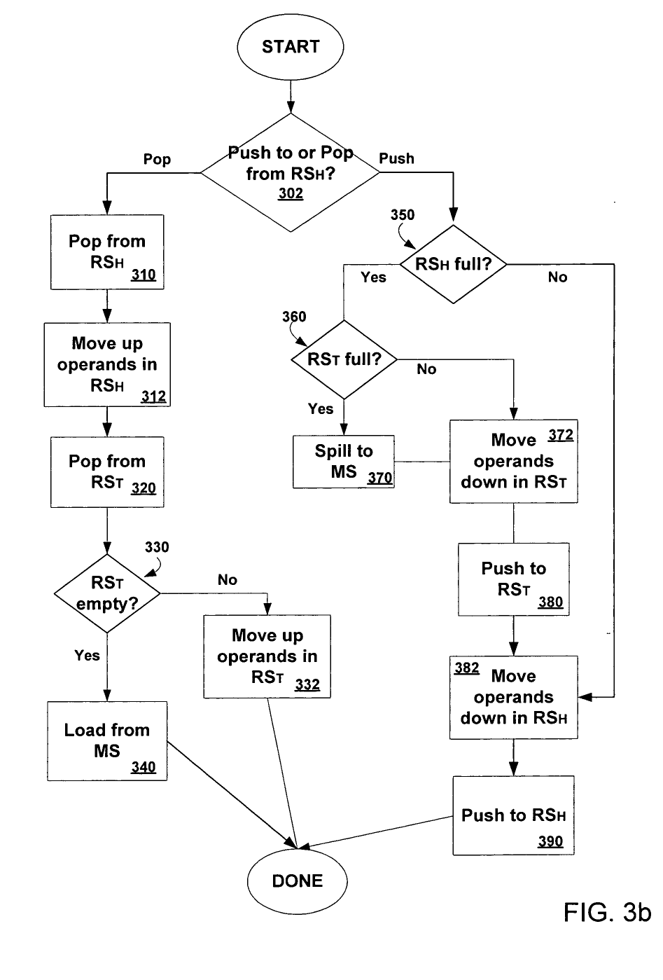

FIG. 1 is a block diagram of a three-stage hybrid stack model according to one embodiment of the invention. FIGS. 3a and 3b are block flow diagrams of a three-stage hybrid stack model according to one embodiment of the invention. Operands are pushed (390) onto the top of the first register stack (head register stack, or RS_{H}) 103 and, more specifically, onto register 110. In order to accommodate a new operand in register 110, any existing operand in register 110 is moved downward to the next register 112. If there is an operand residing in register 112, it must be moved downward in a similar manner to accommodate the operand being moved from register 110. This process of moving operands downward (382) to accommodate new operands continues down the length of the register stack in a cascading fashion until reaching the final register 118 in the head register stack.

In one embodiment, operands are pushed (380) from head register stack 103 onto a transfer register stack 104 when head register stack 103 becomes full (350). More specifically, an operand in register 118 is pushed onto transfer register stack (or RS_{T}) 104 and into register 120.

Transfer register stack 104 receives operands into its registers beginning with register 120, when the overall number of operands in the hybrid stack exceeds the number of registers in the head register stack. Thus, transfer register stack 104 is used to cache operands pushed from head register stack 103 when head register stack 103 is full. Transfer register stack 104 also supplies operands to the head register stack when operands are popped off RS_{H}.

In order to accommodate pushing a new operand onto transfer register stack 104, any operand residing in register 120 is moved down to register 122. Any operand residing in register 122 is similarly moved down to accommodate the operand being moved from register 120. This process of moving operands downward (372) continues down the length of transfer register stack 104 as operands are pushed onto the transfer register stack.

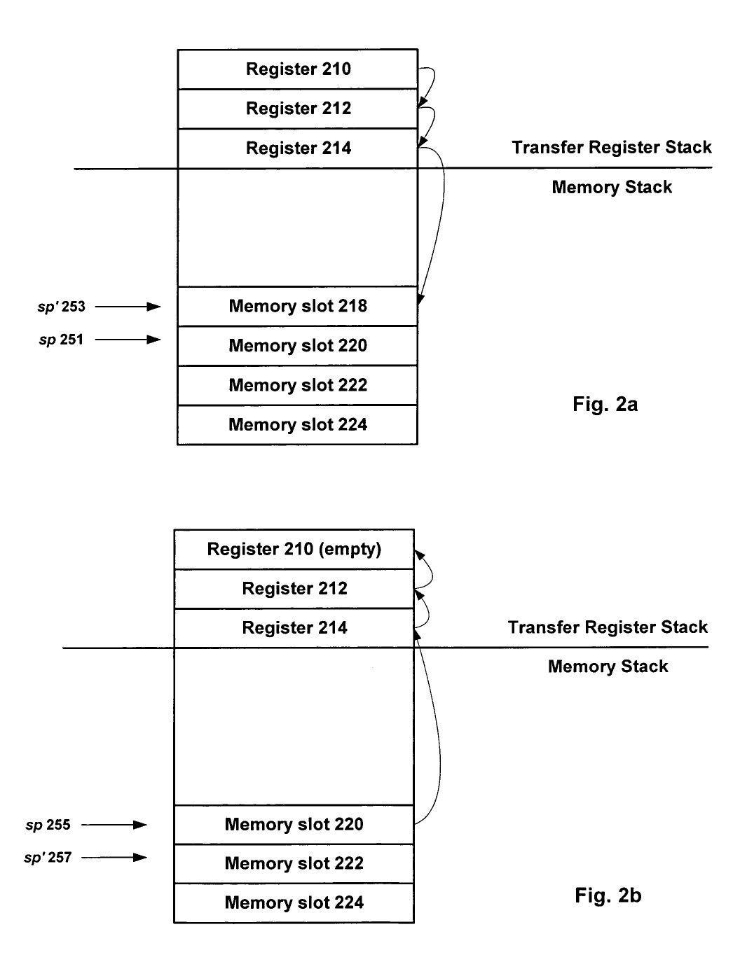

In one embodiment, if both head register stack 103 and transfer register stack 104 are full (360), operands are spilled (370) from transfer register stack 104 into memory stack (MS) 105. Storing operands in the memory stack can involve a cascade of shift operations in memory stack 105. However, in one embodiment, operands are stored in the memory stack by way of a memory store followed by updating a stack pointer. This process is shown in FIG. 2a.

When the transfer register stack overflows, the operand residing in register 214 is spilled into the memory stack. A stack pointer, sp 251, keeps track of the location of the top of the memory stack. As seen in FIG. 2a, stack pointer 251 shows memory slot 220 as the top of the memory stack before a new stack operand is received. Once a new stack operand is received, and assuming the transfer register stack is full, the operand in register 214 is spilled into memory. A new memory slot 218 is created to receive the spilled operand. Upon receiving the new operand into memory slot 218, the stack pointer is updated to sp' 253 so that it points to memory slot 218. In this way, the updated stack pointer always points to the top of the memory stack.

In one embodiment, operands are popped off head register stack 103 as needed for program execution (310). If the current length of the overall hybrid stack is longer than the length of head register stack 103, then operands are popped into head register stack 103 from transfer register stack 104 (320). The popping of operands into head register stack 103 is done in proportion to the number of operands being popped off head register stack 103 for program execution. In other words, operands are popped into head register stack 103 when it is less than full or when it has fewer than a threshold number of operands.

As operands are popped off head register stack 103 for program execution, any remaining operands in head register stack 103 are moved upward in the stack from bottom to top (312). As operands are moved from bottom to top, new operands are popped into the bottom of head register stack 103 from transfer register stack 104. In this way, transfer register stack 104 serves to maintain a threshold number of operands in head register stack 103.

It is not necessary for transfer register stack 104 to be kept full in the same way that head register stack 103 is kept full. The purpose of transfer register stack 104 is to supply head register stack 103 with operands such that head register stack 103 maintains a threshold number of operands.

As operands are popped off transfer register stack 104 and into head register stack 103, remaining operands in transfer register stack 104 are moved upward from bottom to top (332). In one embodiment, operands are loaded into transfer register stack 104 from memory stack 105 when transfer register stack 104 is empty (330, 340). In another embodiment, operands are loaded from memory stack 105 into transfer register stack 104 when it is not empty. The number of operands being loaded into transfer register stack 104 can be fixed or it can be variable. In one embodiment, operands are loaded one by one in proportion to the rate at which operands are being popped off transfer register stack 104. In another embodiment, multiple operands are loaded from memory stack 105 into the transfer register stack concurrently. Any number of operands can be loaded-up to the number of registers in transfer register stack 104. In one embodiment, the number of operands being loaded from memory stack 105 is equal to the number of registers in transfer register stack minus the number of registers in the transfer register stack that are already occupied.

FIG. 2b illustrates how an operand is loaded from the memory stack into the transfer register stack. The stack pointer, sp 255, points to the top of memory stack at memory slot 220. To accommodate the operand from memory slot 220 into the transfer register stack, existing operands in the transfer register stack are moved upward. The operand in register 212 of FIG. 2b is moved into the empty register 210. The operand in register 212 is moved into register 212. With register 214 now empty, the operand from memory slot 220 in the memory stack is loaded into register 214. Once the operand in memory slot 220 has been loaded, the stack pointer is updated to sp' 257 and points to memory slot 222, which is now the top of the memory stack.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the foregoing specification, the invention has been described with reference to specific embodiments thereof. It will, however, be evident that various modifications and changes can be made thereto without departing from the broader spirit and scope of the invention. The specification and drawings are, accordingly, to be regarded in an illustrative rather than a restrictive sense.

What is claimed is:

1. An apparatus comprising:
a head register stack having a plurality of registers to maintain a threshold number of operands therein;
a transfer register stack to receive operands pushed from the head register stack if the head register stack reaches the threshold number of operands, and to supply operands to the head register stack if the head register stack has fewer than the threshold number of operands;
a memory stack to store an operand spilled from the transfer register stack, and to load an operand into the transfer register stack if the transfer register stack is less than full.

2. The apparatus of claim 1 further comprising a processor architecture to push operands onto the head register stack and to receive operands popped from the head register stack.

3. The apparatus of claim 2 wherein the processor architecture further to execute virtual machine instructions.

4. A method of stack caching comprising:
pushing operands from a head register stack into a transfer register stack if the number of operands in the head register stack reaches a threshold number of operands;
popping operands from the transfer register stack to the head register stack when the head register stack has fewer than the threshold number of operands;
spilling operands from the transfer register stack to a memory stack if the number of operands in the transfer register stack exceeds a threshold number of operands;
loading operands from the memory stack into the transfer register stack when the transfer register stack is less than full.

5. The method of claim 4 wherein pushing operands from the head register stack into the transfer register stack further comprises moving remaining operands in the head register stack sequentially from top to bottom.

6. The method of claim 4 wherein popping operands from the transfer register stack to the head register stack further comprises moving remaining operands in the head register stack sequentially from bottom to top.

7. The method of claim 4 wherein spilling operands from the transfer register stack further comprises moving remaining operands in the transfer register stack sequentially from top to bottom.

8. The method of claim 4 wherein loading operands from the memory stack into the transfer register stack further comprises moving remaining operands in the transfer register stack sequentially from bottom to top.

9. The method of claim 4 wherein loading operands from the memory stack into the transfer register stack further comprises moving a stack pointer in the memory stack such that the stack pointer points to the operand at the top of the memory stack.

10. The method of claim 4 wherein spilling operands from the transfer register stack into the memory stack further comprises moving a stack pointer to point to the operand at the top of the memory stack.

11. An article of manufacture comprising a machine accessible medium having content to provide instructions to cause to a machine to perform operations including:
pushing operands from the head register stack into a transfer register stack if the number of operands in the head register stack reaches a threshold number of operands;
popping operands from the transfer register stack to the head register stack when the head register stack has fewer than the threshold number of operands;
spilling operands from the transfer register stack to a memory stack;
loading operands from the memory stack into the transfer register stack when the transfer register stack is less than full.

12. The article of manufacture of claim 11 wherein the operations are performed in a Java thread.

13. The article of manufacture of claim 11 wherein pushing operands from the head register stack to the transfer register stack further comprises moving remaining operands in the head register stack sequentially from top to bottom.

14. The article of manufacture of claim 11 wherein popping an operand from the transfer register stack to the head register stack further comprises moving remaining operands in the head register stack sequentially from bottom to top.

15. The article of manufacture of claim 11 wherein spilling an operand from the transfer register stack further comprises moving remaining operands in the transfer register stack sequentially from top to bottom.

16. The article of manufacture of claim 11 wherein loading an operand from the memory stack into the transfer register stack further comprises moving remaining operands in the transfer register stack sequentially from bottom to top.

17. The method of claim 11 wherein loading operands from the memory stack into the transfer register stack further comprises moving a stack pointer in the memory stack such that the stack pointer points to the operand at the top of the memory stack.

18. The method of claim 11 wherein spilling operands from the transfer register stack into the memory stack further comprises moving a stack pointer to point to the operand at the top of the memory stack.

19. A method of stack caching comprising:
receiving an operand into a head register stack;
pushing an operand from the head register stack into a transfer register stack if the number of operands in the head register stack reaches a threshold number of operands;
popping an operand from the transfer register stack to the head register stack when the head register stack has fewer than the threshold number of operands;
spilling an operand from the transfer register stack to a memory stack if the number of operands in the transfer register stack exceeds a threshold number of operands;
loading an operand from the memory stack into the transfer register stack when the transfer register stack is less than full.

20. The method of claim 19 wherein pushing operands from the head register stack into the transfer register stack further comprises moving remaining operands in the head register stack sequentially from top to bottom.

21. The method of claim 19 wherein popping an operand from the transfer register stack to the head register stack further comprises moving remaining operands in the head register stack sequentially from bottom to top.

22. The method of claim 19 wherein spilling an operand from the transfer register stack further comprises moving remaining operands in the transfer register stack sequentially from top to bottom.

23. The method of claim 19 wherein loading an operand from the memory stack into the transfer register stack further comprises moving remaining operands in the transfer register stack sequentially from bottom to top.

24. A method of stack caching comprising:
supplying an operand to a head register stack from a transfer register stack when the head register stack is in a state of underflow; and
loading operands into the transfer register stack from a memory stack when the transfer register stack is less than full.

25. The method of claim 24 wherein supplying an operand from the transfer register stack further comprises moving remaining operands in the transfer register stack by cascading them from bottom to top.

26. The method of claim 24 wherein loading operands from the memory stack into the transfer register stack further comprises moving remaining operands in the transfer register stack sequentially from bottom to top.

27. The method of claim 24 wherein loading operands from the memory stack into the transfer register stack further comprises moving a stack pointer in the memory stack such that the stack pointer points to the operand at the top of the memory stack.
